(19) United States
(12) Patent Application Publication
(10) Pub. No.: US 2007/0195760 A1
(43) Pub. Date: Aug. 23, 2007

(54) Light weight service discovery protocol

(76) Inventors: Mahfuzur Rahman, Monmouth Junction, NJ (US); Brijesh Kumar, Princeton Junction, NJ (US)

Correspondence Address: Harness, Dickey & Pierce, P.L.C., P.O. Box 828, Bloomfield Hills, MI, 48303, US

(21) Appl. No.: 11/360,620

(22) Filed: Feb. 23, 2006

(51) Int. Cl. H04L 12/56

(52) U.S. Cl. 370/389

(57) ABSTRACT

A service discovery protocol is provided for use in personal area networks and other ad-hoc networking environments. The service discovery protocol is specifically designed to take into account the dynamic network configurations, bandwidth constraints as well as other characteristics of these types of networks. One of the key differentiators of the service discovery protocol is that it relies on a dynamically selected service directory device to manage the amount of information being distributed in the network.

### FIELD OF THE INVENTION

The present invention relates generally to data communication networks and, more particularly, to a service discovery protocol which may be used in data communication networks, in particular, ad-hoc network environments.

### BACKGROUND OF THE INVENTION

In data communication networks, a human user of a network device may need services provided by another network device. For example, a user of a digital camera connected to the network may print a photo using a remote printer that is connected to the same network. To realize such scenarios, a network device should be able to discover other network devices and the services provided by those network devices. A service discovery protocol specifies the mechanism of such service discovery in data communication networks. A known method for such service discovery is having a network device maintain a directory of services available through the devices in the network. Such a network device is called, hereafter, a service directory device. A service directory device aggregates the services from other devices and provides scalability to the service discovery protocols.

When the network devices dynamically join or leave the network, a static configuration about a service directory device is difficult. In particular, even the service directory device may leave the network, in which case, there is a need to select a new service directory device among the remaining network devices. The dynamic nature of ad-hoc networks makes service discovery protocols used in fixed network unsuitable for such networks.

The current generation of service discovery protocols (such as SLP, and SSDP of UPnP) have been designed with fixed network infrastructure in mind. These protocols do not gracefully handle the departure of existing service directory agents or devices since such devices are pre-configured by a network administrator. The role of service directory agents is permanently assigned by configuration to certain nodes that are reliable and generally, always present in the network. This makes these protocols unsuitable for transient ad-hoc networks such as wireless personal area networks where nodes join a network only temporarily. Hence, there is a need to have a service protocol that is lightweight, and self-configuring, and can deal with the departure of central service directory nodes gracefully.

### SUMMARY OF THE INVENTION

In one aspect of the present invention, the service discovery protocol includes: selecting a service directory device from amongst a plurality of network devices that form a network; advertising available services to the service directory device by network devices that form the network; maintaining the available services at the service directory device; and responding to queries regarding the available services from other network devices in the network.

In another aspect of the present invention, the service discovery protocol includes: assigning a priority to each network device which may join a network; selecting a service directory device from amongst a plurality of network devices that form the network based in part on the priority assigned to network devices and/or using device capability information; maintaining network address information at the service directory device for each of the network devices that form the network, thereby enabling service discovery by the network devices.

An important contribution of this invention is to propose a service discovery protocol with in-built method to deal with the failure of service directory devices, and automatic selection of other candidate devices as primary and secondary directory devices based on certain well defined selection criteria. These criteria are designed to best utilize the device capabilities that are important for hand held mobile devices, and include processing power, application preferences, and battery life etc. In addition to optimally utilizing device capabilities, the protocol uses a distributed algorithm that does not rely on presence of any particular node to continue to operate in a reliable manner.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 illustrates an exemplary personal area network;

FIG. 2 illustrates an exemplary messaging scheme for network discovery in accordance with the present invention;

FIG. 3 illustrates an exemplary messaging scheme for service discovery in accordance with one embodiment of the present invention; and

FIG. 4 illustrates an exemplary messaging scheme for service discovery in accordance with another embodiment of the present invention.

### DETAILED DESCRIPTION OF THE PREFERRED EMBODIMENTS

A service discovery protocol according to the principles of the present invention is based on a distributed algorithm tailored for use in a personal area network (PAN). The service discovery protocol may be characterized as a hybrid discovery protocol which is designed to provide fast response as is the case with centralized server based discovery protocols, while still using an intelligent distributed algorithm that does not rely on presence of any permanent networking infrastructure nor any specialized networking node for the sole purpose of enabling service discovery. While the following description is provided with reference to PANs, it is readily understood that the service discovery protocol of the present invention is suitable for use in other types of network environments which lack a permanently fixed networking infrastructure.

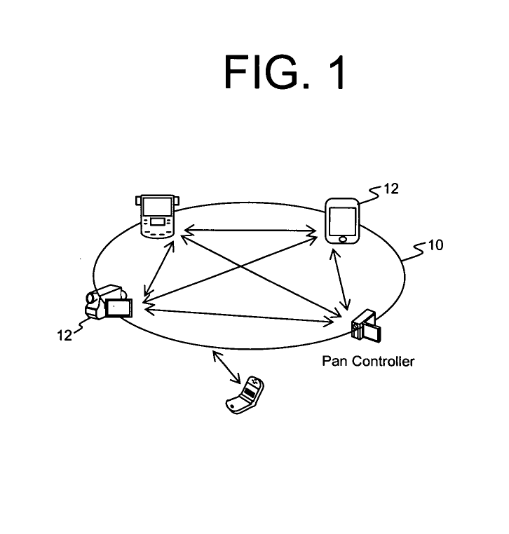

FIG. 1 illustrates an exemplary personal area network (PAN). The PAN 10 is generally comprised of a plurality of network devices 12. One of the network devices assumes the role of a PAN service directory device. Briefly, the PAN service directory device is responsible for providing device identifying and/or service description information to other members of the PAN. The role of PAN service directory device is not assigned to any particular device but is based on a dynamic selection mechanism.

An exemplary selection mechanism is further described below. During device configuration, each network device is assigned a priority for becoming a PAN service directory device. In a particular implementation, the priority may also be derived from the weighted averaging of relative processing power (range 1-4), user preference for being a service directory device (range 0-4), battery life (range 1-4) and other criteria determined by the user. It is possible to use any other mathematical formula instead of weighted average to derive a device's priority. When a network device joins a PAN, it advertises its priority to be a PAN service directory device to other networked devices which form the PAN. The network device with the highest priority from amongst the devices, which form the PAN assumes the role of PAN service directory device. If more than one device in the PAN has the same priority, then the device with the highest numerical IP address becomes the PAN service directory device. It is envisioned that other criteria (e.g., the network device having the most processing power or who joined the network first) may be used to select the PAN service directory device.

To stabilize the role of PAN service directory device, this role is preferably not preemptive. A new network device is not assigned the role of PAN service directory device unless the current PAN service directory device relinquishes its role as service directory device. Thus, the current PAN service directory device may apply some rule set to determine when to relinquish its role, thereby avoiding excessive reassignment of this role. For example, only relinquish the role of service directory device if a predefined period of time has passed since the current service directory device assumed this role. To relinquish itself as the PAN service directory device, the network device may re-advertise its priority level. Once this occurs, the network device having the higher priority level takes over the role of PAN service directory device.

Since PAN devices are often transient, it is also important to define a procedure to detect the departure of the device acting as PAN service directory device. When a new device advertises itself, the current PAN service directory device must respond to it within a predefined time period. A new device will generally try its request up to three times before assuming that a service directory device is no longer part of the network. If there is no response from a PAN service directory device within that time period, the next eligible device assumes the role of PAN service directory device and announces itself as the new PAN service directory device to other PAN devices.

To avoid frequent selection of PAN service directory device, the protocol also assigns a secondary service directory device. The secondary service directory device may take over the role of the primary service directory device if for some reasons the primary directory device becomes unavailable. The identity of both primary and the secondary directory devices is advertised in the messages sent by the service directory agents. The protocol also mandates the use of keep-alive mechanism between the primary and secondary directory agents so that the departure of any of the service directory agents may be detected in the timely manner. The keep-alive mechanism consists of sending a simple message to another device to indicate that a device is alive and available. This would result in automatic and timely re-selection of service directory agents. It is readily understood that other techniques may be employed to detect and replace a departing PAN service directory device.

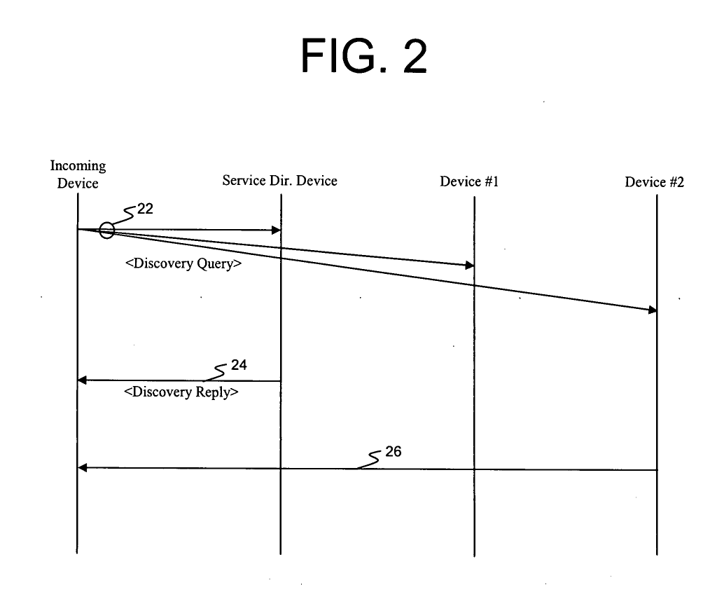

An exemplary messaging scheme for network discovery is shown in FIG. 2. A device looking to discover a PAN will broadcast a discovery query message using a suitable network layer broadcast mechanism as shown at 22. In response to this discovery query message, the PAN service directory device will send a unicast discovery reply message at 24 to the network device. This discovery reply message will include an identifier for the network. In an exemplary embodiment, the identifier is a multicast address for the PAN. Upon receiving this discovery reply message, the joining device can listen to network communications using the multicast address as shown at 26, thereby joining the PAN.

To provide a more secure network environment, the network device may employ a shared security key that is only known to devices which are members in the PAN. Network devices that would like to join the PAN use the shared key to decrypt service discovery messages and other messages sent within the network. A user of a device can manually configure the shared key if it is known to him. Alternatively, a device may learn the shared key from the PAN service directory device. To do so, the broadcast discovery query message sent by an incoming device may include a digital certificate. When responding with the discovery reply message, the PAN service directory device may encrypt the shared key with the incoming device's public key. Once the discovery reply message is received by the incoming device, it will decrypt the shared key using its public key and then use this shared key for further communication within the PAN. It is readily understood that other types of security measures are within the broader aspects of the present invention.

A service discovery mechanism is another important aspect of the present invention. After a device discovers a PAN, it then proceeds to advertise its available services to the PAN service directory device. In one exemplary embodiment, the PAN service directory device may dictate the service description format. The PAN service directory device communicates the service description format in the discovery reply message sent to each incoming network device. In an alternative embodiment, the network devices are pre-configured with the appropriate service description format. In either case, all devices periodically refresh their service information with the PAN service directory device.

Service description formats are used to describe both the device and its available services. In particular, the format specifies device properties, service name, type, attribute, keywords, properties and functions so that a client device can make use of the services provided by the device. An exemplary XML-based service description format is shown below.

```
<?xml version = “1.0”>
<scopeparameters> Parameters for scoping </scopegroup>
// Description of Device Identification data //
<device> Description of Device - device data will be encrypted
Device Name = “PVR Recorder”
  Manufacturer= “Panasonic”
Model= “GSV12”
DeviceType= “simple” // A device may be a composite device
  </device>
// List of services offered by the devices - service data will be encrypted //
      <serviceList>
      <service> Record </service>
      <service> Play </service>
      ... ...
    <service> Service n </service>
  </serviceList>
/<device>
```

### The above example is provided for illustration purpose and is not intended to limit the scope of the present invention.

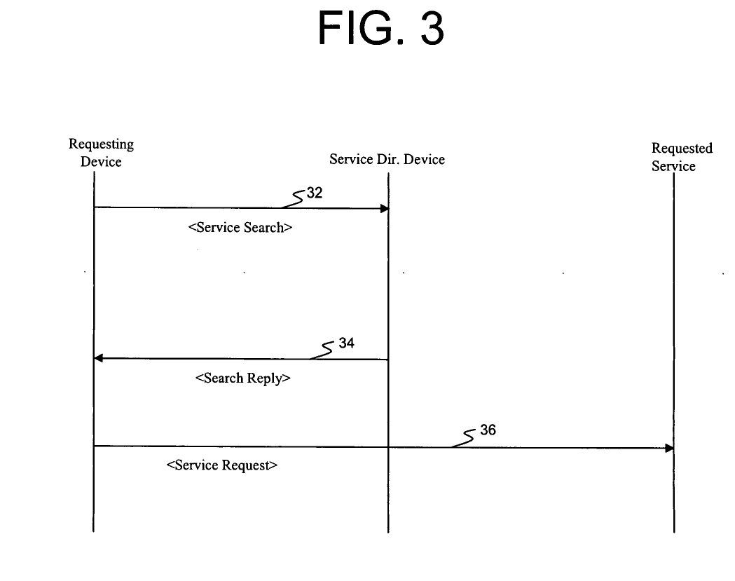

In one exemplary embodiment, the PAN service directory device maintains an inventory of services available from the network devices in the PAN. An exemplary messaging scheme is further described in relation to FIG. 3. To discover a service, any of the network devices in the PAN may send a service search message to the PAN service directory device as indicated at 32. Scoping parameters embodied in the search message define the type of service the requesting device is interested in. The service search message is preferably sent as a unicast message directly to the service directory device. The PAN service directory device replies with a service search reply message at 34 that outlines any available services which meet the requester's criteria. The service search reply message is also sent as a unicast message. The requesting device can then directly interface with the service providing device as shown at 36.

When a device leaves the PAN, it sends a service withdrawal message to the PAN service directory device. The PAN service directory device is turn removes the services provided by the departing device from its inventory. Thus, these services are no longer available to the remaining devices which form the PAN.

Similarly, the PAN service directory device may maintain a list of current PAN members, optionally their device types and a corresponding IP address for the member device. In this case, the PAN service directory device replies to a service search message with a list of current members. The requesting device can then query one or more of the PAN members directly to obtain service information.

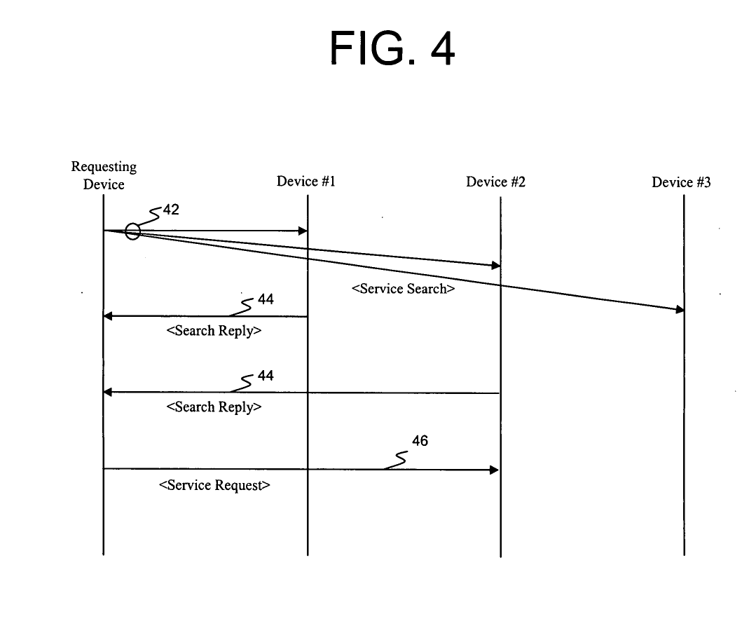

In an alternative approach, a requesting device can send a service search message directly to the other devices in the PAN as shown in FIG. 4. In this case, the service search message is sent as a multicast message at 42 using the multicast address previously provided to it by the PAN service directory device. In response to this message, the requesting device may receive multiple service search reply messages as shown at 44, where each message is sent via a unicast message. The requesting device can then resolve multiple responses prior to requesting a desire service as indicated at 46.

An alternative approach for forming a PAN is described below. Upon entering a new area, a single designated mobile device is responsible for forming the PAN. The designated mobile device assumes the role of PAN service directory device and advertises itself as such. Other network devices in the area respond to broadcast messages, thereby forming a PAN. For instance, the other devices may advertise their available services to the PAN service directory device. Service discovery may otherwise occur as described above. When the designated mobile device leaves the area, none of the remaining devices are permitted to become the PAN service directory device. Thus, the logical association is terminated and the PAN is terminated.

The service discovery protocol of the present invention is able to support multiple PANs in the same physical space. An identifier for each PAN and the optional use of a security key maintains separation between two or more existing PANs. The identifier also serves to limit the search scope to the subset of devices that constitute a given PAN. Although it may be preferable that each PAN have a different device serve as its PAN service directory device, it is envisioned that a given network device may serve as a PAN service directory device in two or more PANs.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A service discovery protocol for a network, comprising:
selecting a service directory device from amongst a plurality of network devices that form a network;
advertising available services to the service directory device by network devices that form the network;
maintaining the available services at the service directory device; and
responding to queries regarding the available services from other network devices in the network.

2. The service discovery protocol of claim 1 wherein selecting a service directory device further comprises assigning a priority to each network device which may join an ad-hoc network during device configuration; and selecting the service directory device from amongst a plurality of network devices that form the network based in part on the priority assigned to network devices.

3. The service discovery protocol of claim 1 further comprises communicating an identifier for the network by the service directory device to network devices that form the network.

4. The service discovery protocol of claim 3 wherein the identifier is further defined as a multicast address for the network devices that form the network.

5. The service discovery protocol of claim 1 further comprises communicating a service description format by the service directory device to the network devices that form the network.

6. The service discovery protocol of claim 5 wherein advertising available services to the service directory device further comprises using the service description format provided by the service directory device.

7. The service discovery protocol of claim 1 wherein advertising available service to the service directory device further comprises sending a unicast message to the service directory device.

8. The service discovery protocol of claim 1 further comprises requesting service discovery by sending a unicast message to the service directory device.

9. The service discovery protocol of claim 1 further comprises selecting a different service directory device from amongst the plurality of network devices that form the network when the service directory device departs the network.

10. The service discovery protocol of claim 1 further comprises communicating a shared security key by the service directory device to the network devices that form the network.

11. The service discovery protocol of claim 1 further comprises selecting a service directory device for a different ad-hoc network from amongst a plurality of network devices, wherein at least one of the network devices resides in each of the networks.

12. The service discovery protocol of claim 11 wherein the same network device serves as the service directory device in each of the networks.

13. A service discovery protocol for a network, comprising:
assigning a priority to each network device which may join a network;
selecting a service directory device from amongst a plurality of network devices that form the network based in part on the priority assigned to network devices;
maintaining network address information at the service directory device for each of the network devices that form the network, thereby enabling service discovery by the network devices.

14. The service discovery protocol of claim 13 further comprises selecting a different service directory device from amongst the plurality of network devices that form the network when the service directory device departs the network.

15. The service discovery protocol of claim 13 wherein selecting a service directory device further comprises selecting a network device having the highest priority as the service directory device.

16. The service discovery protocol of claim 15 wherein selecting a service directory device further comprises selecting a network device having the highest numerical network address when at least two network devices have the same highest priority.

17. The service discovery protocol of claim 13 further comprises advertising the priority of a given network device upon the given network device joining the network and assessing the selection of the service directory device in view of the priority of the given network device.

18. The service discovery protocol of claim 17 wherein the assessment of the service directory device selection is performed by the service directory device in accordance with a predefined rule set, whereby excessive reassignment of the service directory device may be avoided.

19. The service discovery protocol of claim 13 further comprises receiving network address information for a given network device from the service directory device and requesting service discovery from the given network device using the network address information.

20. The service discovery protocol of claim 13 further comprises broadcasting a discovery messages from a given network device to inquiry as to the existence of the network.

21. The service discovery protocol of claim 20 wherein the discovery message includes a public key for the given network device.

22. The service discovery protocol of claim 20 further comprises responding to the discovery message by communicating a shared security key from the service directory device to the given network device.

23. A service discovery protocol for a network, comprising:
introducing a controlling network device into a potential ad-hoc network location;
broadcasting a service query message from the controlling network device to any other network devices residing in the potential ad-hoc network location, where the service query message includes an identifier for a network; and
advertising available services from at least one other network device to the controlling network device in response to the service query message, thereby forming the network.

24. The service discovery protocol of claim 23 wherein the identifier is further defined as a multicast address for the network devices that form the network.

25. The service discovery protocol of claim 23 further comprises communicating a service description format by the controlling network device to the other network devices that form the network.

26. The service discovery protocol of claim 25 wherein advertising available services to the service directory device further comprises using the service description format provided by the controlling network device.
